(19) United States
(12) Patent Application Publication
(10) Pub. No.: US 2003/0163806 A1
(43) Pub. Date: Aug. 28, 2003

(54) Software downloading system for data transmission device

(76) Inventors: Nobuki Nakata, Kawasaki (JP); Takashi Nagato, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/379,109

(22) Filed: Feb. 27, 2003

Related U.S. Application Data
(63) Continuation of application No. PCT/JP00/05898, filed on Aug. 30, 2000.

(51) Int. Cl. G06F 9/44; G06F 9/445

(52) U.S. Cl. 717/173; 717/178

(57) ABSTRACT

A method and system are disclosed, which simplify the software downloading (SWDL) procedure without changing the existing device configuration and allows software downloading to be executed in a short time. The software downloading system includes a plurality of transmission devices connected to a network, each of which is controlled by software; and a supervisory device connected to the network; wherein each of the transmission devices has a memory receiving and storing the software data to be downloaded from the supervisory device; and a control section for controlling, within the transmission device, downloading of the software data into corresponding target address locations through vacant time slots of a transmission line through which main signals are transmitted.

### BACKGROUND OF THE INVENTION

1. Technical Field of the Invention

The present invention relates to a software downloading system for a transmission device, esp., an access-related transmission device supporting the V5.2 (ITU-T recommendation) interface.

2. Prior Art

Recent years have seen rapid software orientation of transmission devices. Particularly, access-related transmission devices′ connection with PSTN (Public Switched Telephone Network), ISDN (Integrated Services Digital Network) and digital PABX have increased in complexity.

Also for individual services, PSTN offers functions such as 2-/4-wire and presence or absence of billing feature/64K service while ISDN offers functions including basic rate and primary rate.

Further, not only PDH (Plesiochronous Digital Hierarchy) and SDH (Synchronous Digital Hierarchy) but also a test unit for carrying out subscriber tests exist on the higher-order group side, and in the case of the ITU-T-recommended V5 system, there are additional units such as control unit for controlling the V5 protocol and unit for conducting in-device cross-connect, thus resulting in a growing number of unit types developed with diversification of services and increase in number of devices.

However, software which controls such units varies from one unit to another, as a result of which it is necessary to download many types of software for each unit.

Therefore, software downloading (SWDL) into transmission devices is carried out in a manner described below. One logs into a transmission device from the supervisory device side, selects files needed for individual units within the transmission device, selects units one at a time and executes SWDL on an individual basis.

Alternatively, one selects necessary files from the supervisory device side and transfers them to the storage portion of the target device in advance. Then, one selects units within the transmission device which need SWDL and executes SWDL from the storage portion into the target units. However, these methods require that the supervisory device side (operator) check what types of service units are incorporated in each transmission device in advance before transmitting files. Moreover, an enormous number of operations and amount of time were needed to select service units one at a time and carry out SWDL on an individual basis after transmission of files.

To solve the problems, the following methods have been proposed until now:

1) The software controlling device queries individual terminals about necessary pieces of software, selects requested pieces of software according to the response and sends them to terminals. Such a method is disclosed in Japanese Patent Application No. Hei8-523471.

2) Information on devices which can receive software (e.g., hardware version/software version) is attached to software when software is transferred, and software can be loaded only when information of the receiving side matches the attached information.

With both of methods 1) and 2), although the process of file transmission to terminals can be simplified, it is still necessary to perform operations for downloading software into in-device units and so on, and this point remains unsolved. For this reason, software downloading procedure was complicated and time-consuming.

### SUMMARY OF THE INVENTION

It is therefore an object of the present invention to provide a method which simplifies the software downloading (SWDL) procedure without changing the existing device configuration and allows software downloading to be executed in a short time.

Another object of the present invention is to provide a software downloading system for a transmission device which allow prompt software downloading with almost no operations required down to individual units within the device.

A software downloading system in accordance with the present invention to achieve the above objects comprises a plurality of transmission devices connected to a network, each of which is controlled by software; and a supervisory device connected to the network; wherein each of the transmission devices includes a memory receiving and storing the software data to be downloaded from the supervisory device; and a control section for controlling, within the transmission device, downloading of the software data into corresponding target address locations through vacant time slots of a transmission line through which main signals are transmitted.

In a preferred aspect of the software downloading system in accordance with the present invention to achieve the above objects, the software data is transmitted in a message format defined only within the transmission device.

In another preferred aspect of the software downloading system in accordance with the present invention to achieve the above objects, software data, received from the network and stored in the memories, is compressed and then decompressed by the control section and transmitted through the vacant time slots after transfer information sequence numbers are attached thereto.

In yet another preferred aspect of the software downloading system in accordance with the present invention to achieve the above objects, the network has the V5.2 protocol and wherein the message format defined only within the transmission device is differentiated by the definition in the V5.2 Layer 3 message format and by a specific identifier.

In still another preferred aspect of the software downloading system in accordance with the present invention to achieve the above objects, the target address locations, into which the software data is to be downloaded, are uniquely defined by slot numbers based on V5.2 Layer 3 message.

In a further preferred aspect of the software downloading system in accordance with the present invention to achieve the above objects, the control section monitors the vacancy statuses of the vacant time slots of the transmission line through which the main signals are transmitted, and wherein when a plurality of vacant time slots are available, the control section transfers the software data using the plurality of vacant time slots.

In a yet further preferred aspect of the software downloading system in accordance with the present invention to achieve the above objects, the control section sends a checksum of the software data to the target address locations at the completion of the software data downloading such that a checksum of the software data downloaded into the target address locations is compared with the checksum sent by the control section for determination as to whether software data downloading functions properly.

Features of the present invention will become more apparent from the following embodiments of the present invention which are described with reference to the drawings.

### BRIEF DESCRIPTION OF THE DRAWINGS

FIG. 1 illustrates a network configuration including transmission devices to which the present invention is applied;

FIG. 2 illustrates an example of services supported by individual transmission devices in the network shown in FIG. 1;

FIG. 3 illustrates a format structure of the V5.2 Layer 3 message portion;

FIG. 4 illustrates an example of detailed configuration of message type 22;

FIG. 5 illustrates an example of message format (FIG. 5B) for SWDL applicable only within transmission devices using the V5 Layer 3 message format (FIG. 5A) shown in FIG. 3 according to the present invention;

FIG. 6 illustrates a detailed example of SWDL message type 42;

FIG. 7 illustrates an example of configuration of transmission device describing the execution of SWDL according to the present invention; and

FIG. 8 is a flowchart representing processing steps in the transmission device shown in FIG. 7.

### MODE FOR CARRYING OUT THE INVENTION

An embodiment of the present invention will now be described with reference to the drawing. It is to be noted that the embodiment described in the drawings is for understanding of the present invention and that the application of the present invention is not limited thereto.

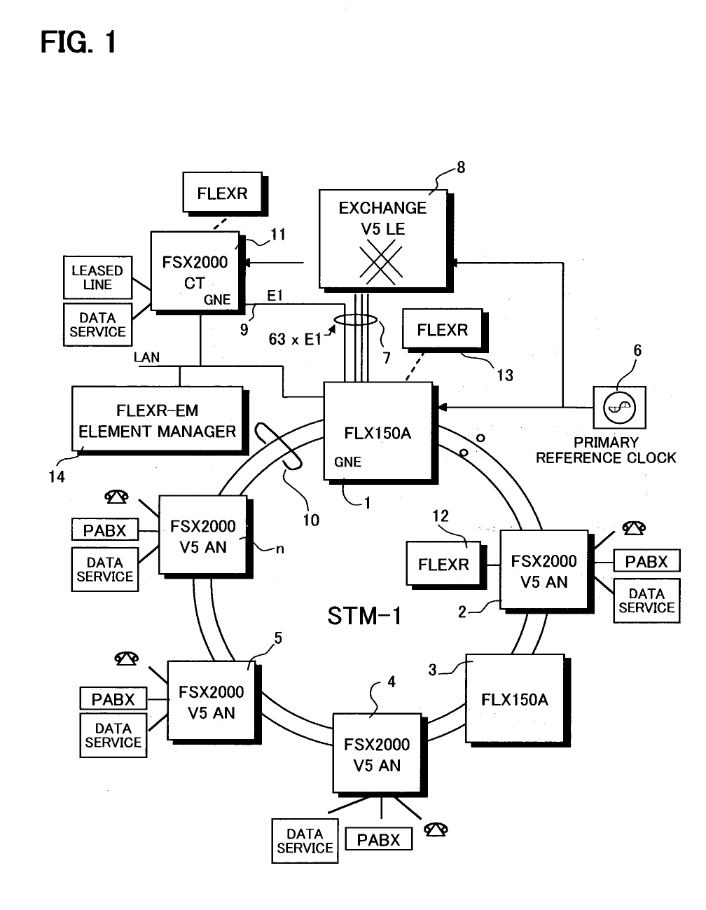

FIG. 1 illustrates a network configuration including transmission devices to which the present invention applies. The network shown in FIG. 1 consists of STM (Synchronous Transport Module)-1 (2,016 channels=155.52 Mbps in terms of 64 bps). A plurality of STM-1-compliant transmission devices 1 through n are connected to the nodes of a public network's transmission line 10. A reference clock source 6, used to comprise SDH (Synchronous Digital Hierarchy), is connected to the transmission device 1.

The transmission device 1 is further connected to an exchange 8 through a V5.2 protocol interface 7 and to a leased line transmission device 11 through a leased line transmission line 9. Further, supervisory devices 12, 13 and 14, operated by the operator and designed for use with the PC or workstation, are connected in FIG. 1.

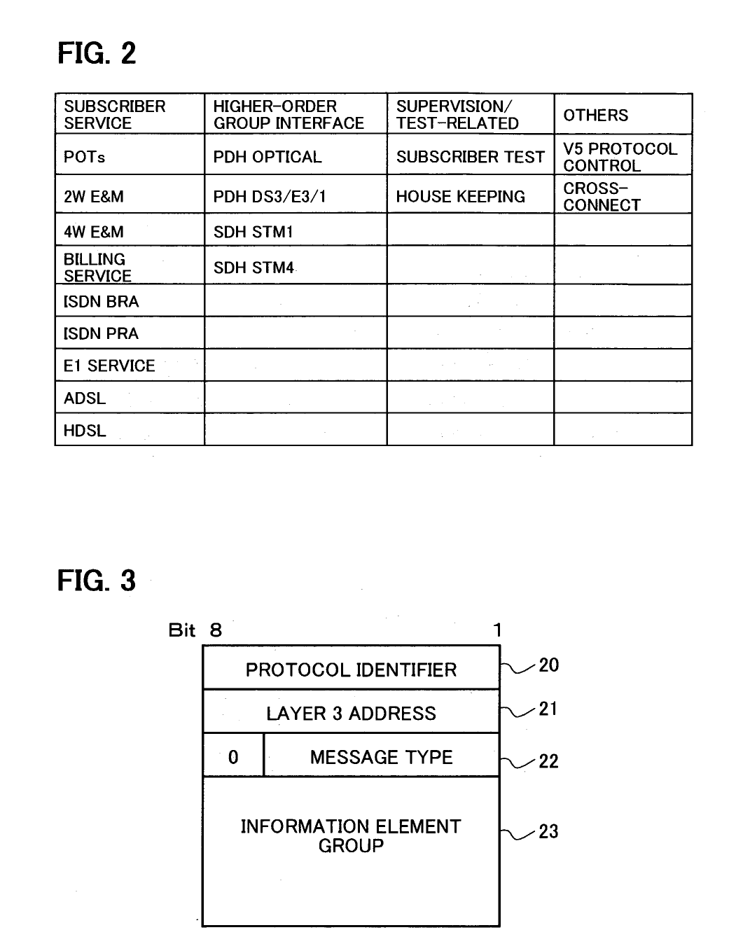

FIG. 2 illustrates an example of services supported by individual transmission devices in the network shown in FIG. 1. Subscriber services, higher-order group interface and supervision-/test-related services are among those provided.

Here, when a large number of services as described above are provided by a single transmission device, the present invention provides a method which allows a variety of service units, contained in the device, to effectively download software (execute SWDL) without the need for the operator to go through complicated operation procedure and further prevents degradation in the device's alarm and control processing performance during SWDL.

The present invention applies to transmission devices compliant with V5.2 , an international standard for interface between access-related devices and exchanges, and carries out SWDL by taking advantage of the V5.2's features.

FIG. 3 illustrates a format structure of the V5.2 Layer 3 message portion. A protocol identifier 20 is a code designed to identify the V5 protocol.

A Layer 3 address 21 represents the Layer 3 entity of a transmitted/received message. This allows the system to determine to which port the received data is to be connected.

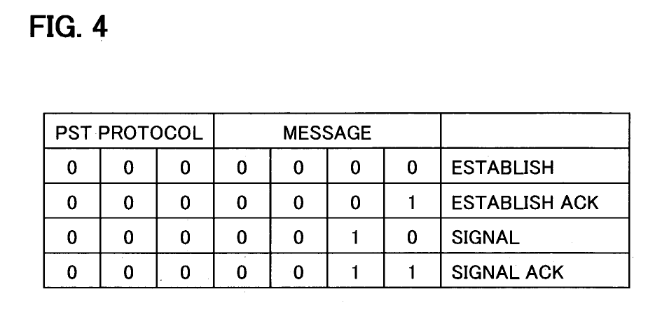

A message type 22 is used to verify the function of a protocol or message. An example of detailed format is shown in FIG. 4. For example, it is possible to determine, for example, that a message is a PSTN message when bits 5, 6 and 7 are 000 and that a message is a BCC protocol message when the bits are 010.

The message type 22 further has a detailed message which is determined by the values of bits 1 through 4. FIG. 4 shows one example. The detailed message represents ESTABLISH, ESTABLISH ACK, SIGNAL and SIGNAL ACK respectively when this field contains “0000”, “0001”, “0010” and “0011.”

In FIG. 3, control information (e.g., ON HOOK/OFF HOOK) required for call control associated with the message type 22 is contained in an information element group 23.

These definitions are standardized only in transmission between transmission devices and exchanges. Therefore, these definitions can be changed within transmission devices in any manner.

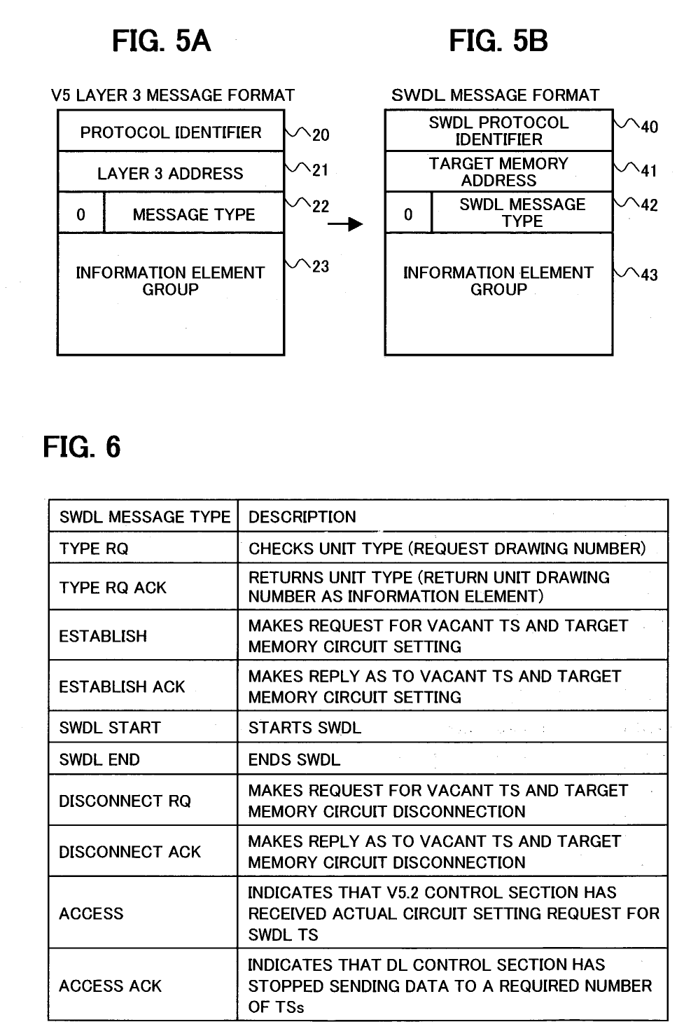

The present invention has been made possible by noting this point. FIG. 5 illustrates an example of SWDL message format (FIG. 5B) applicable only within transmission devices using the V5 Layer 3 message format (FIG. 5A) shown in FIG. 3 according to the present invention.

In FIG. 5B, an SWDL protocol identifier 40 determines whether a protocol is the V5 protocol or a protocol for SWDL. A target memory address 41 is uniquely defined by a shelf number or slot number and represents a memory address into which firmware to be downloaded should be loaded.

An SWDL message type 42 sets, resets and checks circuits for SWDL. Further, an information element group 43 is used for notification of SWDL statuses (e.g., vacant time slot TS information, SWDL progress information). Moreover, a detailed example of the SWDL message type 42 is shown in FIG. 6.

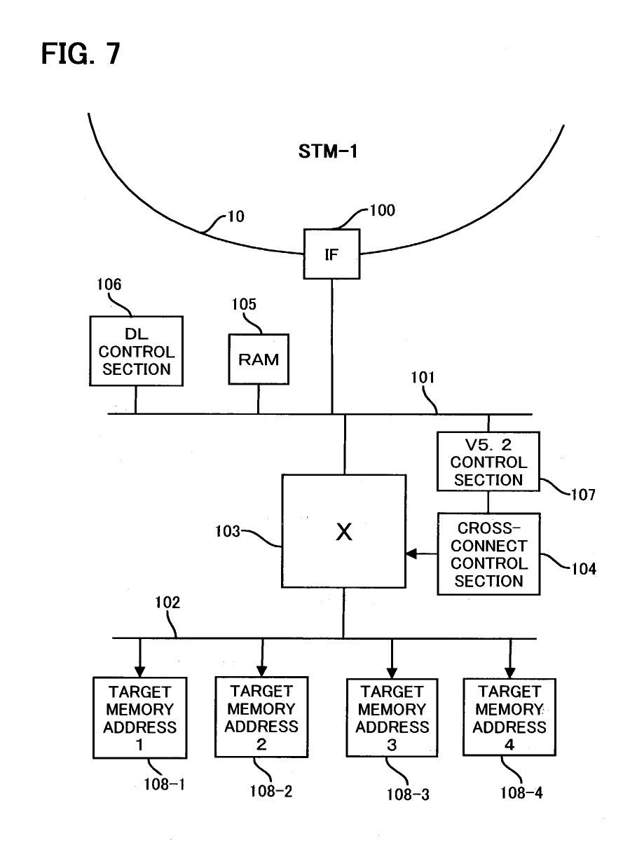

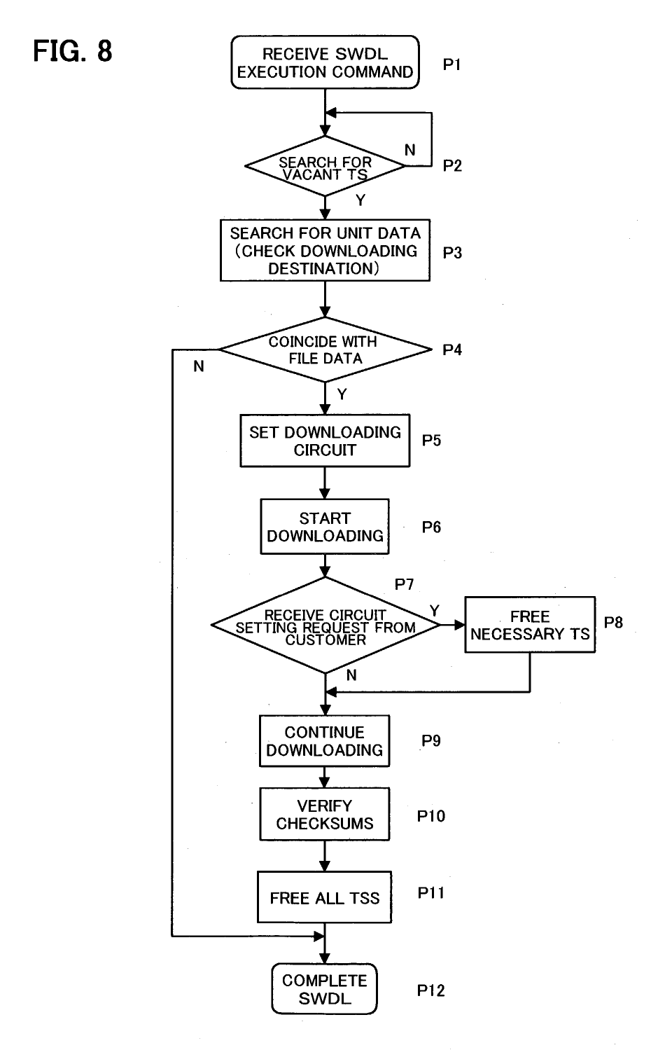

FIG. 7 illustrates an example of transmission device configuration describing the execution of SWDL according to the present invention while FIG. 8 is a flowchart representing processing steps for the SWDL execution.

In FIG. 7, the transmission device is connected to the STM-1 transmission line 10 via an interface 100.

A cross-connect device 103 is provided between buses 101 and 102, and the cross-connect device 103 is controlled by a cross-connect control section 104. A RAM 106, which temporarily stores downloaded data and a downloading (SWDL) control section 106 are connected to the bus 101.

Moreover, a V5.2 control section 107, which controls the V5.2 protocol, is connected to the cross-connect control section 104. On the other hand, memories 108-1 through 108-4, corresponding to a plurality of memory addresses which will serve as a plurality of destinations for downloading, are connected to the bus 102.

Here, if software is modified (version update due to upgrading or bug fix), a series of modified software data is compressed, for example, in the supervisory control section 13 connected to the transmission device 1.

Then, compressed software data is transferred as a single unit to the RAM 105 whose read/write operations are controlled by the SWDL control section 106 of the transmission device which receives data. At this time, the modified software to be transferred is sent in the SWDL message format shown in FIG. 5B.

Further, compressed software transferred to the RAM 105 is decompressed by the SWDL control-section 106 and restored to a series of files. This group of files is inserted into main signal's vacant time slots and downloaded into the memories 108-1 through 108-4 of the predetermined target addresses by the function according to the flow shown in FIG. 7 which will be described next.

The SWDL control section 106 starts its control as follows when it receives an SWDL execution command from the operator (processing step P1 in FIG. 8):

First, it checks vacancy statuses by the V5.2 control section 107 based on main signal's 64 Kbps time slots TS (processing step P2). This function must be always available to provide the concentration function defined for V5.2-compliant systems.

If there are no vacant time slots (processing step P2: NO), the V5.2 control section 107 sends a message to that effect back to the downloading (DL) control section 106 as information element. If it receives a message that there are no vacancies, it temporarily halts SWDL and checks for vacancy statuses on a regular basis.

When vacancies occur in time slots TS, the DL control section 106 inserts the SWDL protocol identifier 40 into a protocol identifier for differentiation from the V5.2 protocol. Since this identifier is used only within the transmission device, it can be any value other than the V5.2 protocol identifier (01001000).

Next, it checks which units are contained in which slots. Then, it determines which pieces of firmware are to be downloaded into which slots. For this reason, the following message and procedure are executed:

The DL control section 106 sends a unit type confirmation, that is, a unit drawing number request (TYPE RQ) and target memory address to the V5.2 control section 107. The V5.2 control section 107 extracts the unit drawing number stored in the target memory address and sends it back to the DL control section 106 as information element and also as reply (TYPE RQ ACK) to unit type request.

This operation is repeated to check which units are contained in all slots (processing step P3). Then, the DL control section 106 selects firmware requested for each slot based on this information and determines the order in which SWDL is executed (processing step P4).

Next, it checks time slot TS vacancy information to send an ESTABLISH message, a message transmitted as reply to vacant time slot and target memory circuit setting request, to the V5.2 control section 107. This allows time slots for executing SWDL, the SWDL data transmission port of the DL control section 106 (64 Kbps-based) and circuits between target memories to be set (processing step P5).

Moreover, the memory units' side (108-1 to 108-4) which is subject to SWDL checks the SWDL protocol identifier, the target memory address information and time slots TS assigned for that purpose and assigns data on those time slots TS to the target memory ports.

The V5.2 control section 107 is notified of these statuses and sends an ESTABLISH ACK message back to the DL control section 106 for each memory address when it confirms that circuits have been established.

As many time slots TS are assigned as the number of pieces of firmware to be downloaded (SWDL). However, if there are more vacant time slots TS than firmware types, it is possible to assign a plurality of time slots TS for SWDL.

When the DL control section 106 confirms that circuits have been established, it sends an SWDL start (SWDL START) message to the V5.2 control section 107 to notify this section that that circuits are being used for SWDL and initiates SWDL at the same time (processing step P6).

Further, the DL control section 106 divides SWDL information into blocks of predetermined length and attaches a sequence number to each of the blocks. These sequence numbers are used to properly rearrange data received by the receiving side (the target memories 108-1 through 108-4) if SWDL is executed using a plurality of time slots TS.

Note that if the V5.2 control section 107 receives a circuits setting request from a customer during SWDL (processing step P9), the V5.2 control section 107 notifies the DL control section 106 that it will free the requested number of circuits from the SWDL circuit setting (processing step P8).

Consequently, the DL control section 106 stops sending data to the requested number of time slots TS and sends an ACCESS ACK message back to the V5.2 control section 107 along with the corresponding time slot TS numbers.

Sequence numbers are used to ensure that SWDL data is written in proper sequence also when time slots TS are freed for SWDL as described above.

Thus, when downloading continues (processing step P9) and the DL control section 106 finishes sending the last block of firmware, this section sends firmware's checksum to the target memories 108-1 through 108-4 for comparison with the checksum calculated by the target memories (processing step P10).

When these compared values match, the DL control section 106 is notified of this fact and sends an SWDL END message, representing the end of SWDL, to the V5.2 control section.

On the other hand, the V5.2 control section 107 frees TSs assigned for SWDL (processing step P11) and completes SWDL (processing step P12). Naturally, if checksums do not match, the SWDL is repeated.

### INDUSTRIAL APPLICABILITY

As discussed hereinabove, it is possible to simplify heretofore complicated and time-consuming SWDL procedure and perform SWDL in a short time according to the present invention.

Further, use of the V5.2 protocol provides SWDL modules simply by adding such modules to individual units without changing existing hardware configuration.

What is claimed is:

1. A software downloading system comprising:
a plurality of transmission devices connected to a network, each of which is controlled by software; and
a supervisory device connected to the network;
wherein each of the transmission devices includes:
a memory receiving and storing the software data to be downloaded from the supervisory device; and
a control section for controlling, within the transmission device, downloading of the software data into corresponding target address locations through vacant time slots of a transmission line through which main signals are transmitted.

2. A software downloading system according to claim 1, wherein the software data is transmitted in a message format defined only within the transmission device.

3. A software downloading system according to claim 2, wherein software data, received from the network and stored in the memories, is compressed and then decompressed by the control section and transmitted through the vacant time slots after transfer information sequence numbers are attached thereto.

4. A software downloading system according to claim 2, wherein the network has the V5.2 protocol and wherein the message format defined only within the transmission device is differentiated by the definition in the V5.2 Layer 3 message format and by a specific identifier.

5. A software downloading system according to claim 4, wherein the target address locations, into which the software data is to be downloaded, are uniquely defined by slot numbers based on V5.2 Layer 3 message.

6. A software downloading system according to claim 1, wherein the control section monitors the vacancy statuses of the vacant time slots of the transmission line through which the main signals are transmitted, and wherein when a plurality of vacant time slots are available, the control section transfers the software data using the plurality of vacant time slots.

7. A software downloading system according to claim 1, wherein the control section sends a checksum of the software data to the target address locations at the completion of the software data downloading such that a checksum of the software data downloaded into the target address locations is compared with the checksum sent by the control section for determination as to whether software data downloading functions properly.
